(19) United States
(12) Patent Application Publication
(10) Pub. No.: US 2025/0271101 A1
(43) Pub. Date: Aug. 28, 2025

(54) Tolerance Adjuster

(71) Applicant: Illinois Tool Works Inc., Glenview, IL (US)

(72) Inventors: Zhilin Li, Shanghai (CN); Mengli Sun, Shanghai (CN); Weibin Liu, Shanghai (CN)

(21) Appl. No.: 19/060,204

(22) Filed: Feb. 21, 2025

(30) Foreign Application Priority Data
Feb. 27, 2024 (CN) 2024102182313

(51) Int. Cl. F16M 13/02; E05B 79/06; E05B 85/10

(52) U.S. Cl. CPC F16M 13/022; E05B 79/06; E05B 85/103

(57) ABSTRACT

The present disclosure provides a tolerance adjuster, including a housing, a fastener and a centering structure. The housing is a vertically through cylindrical body and includes an inlet and an outlet that are opposite to each other, and the housing defines a channel. The fastener is arranged partially in the channel. The centering structure is cooperatively connected to the fastener and the housing such that the fastener is movable axially back and forth in the channel and the fastener is kept substantially on a central axis of the housing. A hidden vehicle door handle can be mounted to an interior sheet metal of a vehicle door after the hidden vehicle door handle is aligned with an exterior sheet metal of the vehicle door, such that the hidden vehicle door handle can be mounted easily and reliably. The centering structure is cooperatively connected to the fastener to prevent the centering structure from being disengaged from the fastener after radial movement of the fastener, such that the centering structure does not need to be reassembled.

### RELATED APPLICATION

The present application claims the benefit of Chinese Patent Application No. 2024102182313, filed Feb. 27, 2024, each titled “Tolerance Adjuster,” the contents of which are hereby incorporated by reference.

### TECHNICAL FIELD

The present disclosure relates to a tolerance adjuster, and in particular to a tolerance adjuster for a hidden vehicle door handle.

### BACKGROUND

With the development of the society and the improvement of people's living standards, electric vehicles have become indispensable vehicles for people's daily travel, and a hidden vehicle door handle is a feature product of intelligence of the electric vehicle.

The hidden vehicle door handle needs to be flush with an exterior sheet metal outside a vehicle door to make a vehicle have good appearance. In operation, an outside portion of the hidden vehicle door handle passes through the exterior sheet metal, and then a base of the hidden vehicle door handle is fastened to an interior sheet metal inside the vehicle door. The interior sheet metal is usually welded to the inside of the vehicle door. Since it is difficult for a welding process to ensure the accuracy of an installation dimension of the interior sheet metal inside the vehicle door, there may be a gap surface difference between the hidden vehicle door handle fixed to the interior sheet metal and the exterior sheet metal. At present, a common solution to make the hidden vehicle door handle flush with the exterior sheet metal is to adjust, using a tolerance adjuster, an installation dimensional error caused by welding of the interior sheet metal, such that the hidden vehicle door handle is flush with the exterior sheet metal of the vehicle door. If the tolerance adjuster is not used, it is necessary to check the gap surface difference between the hidden vehicle door handle and the exterior sheet metal for several times during the installation, which is a great waste of installation time.

The tolerance adjuster includes a housing and a fastening portion mounted in the housing, the housing is mounted to the base of the hidden vehicle door handle and extends from the base toward the interior sheet metal inside the vehicle door by a certain distance, and the fastening portion extends from the inside of the housing toward the interior sheet metal for mounting to the interior sheet metal. When the housing is mounted to the base of the hidden vehicle door handle and the fastening portion is mounted to the interior sheet metal, the housing abuts against the interior sheet metal. That is, the tolerance adjuster is connected between the interior sheet metal and the base of the hidden vehicle door handle, and the distance by which the housing of the tolerance adjuster extends from the base toward the interior sheet metal inside the vehicle door is used for adjusting the gap surface difference between the hidden vehicle door handle and the exterior sheet metal such that the hidden vehicle door handle is flush with the exterior sheet metal.

### SUMMARY OF THE DISCLOSURE

The present disclosure relates generally to a tolerance adjuster, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a structural schematic diagram of a tolerance adjuster used to mount a hidden vehicle door handle of a vehicle to a panel of the vehicle according to the present disclosure.

FIG. 1B is a front view of FIG. 1A.

FIG. 1C is an exploded view of FIG. 1A.

FIG. 2 is an exploded view of the tolerance adjuster.

FIG. 3 is a cross-sectional view of the tolerance adjuster in an assembled state.

FIG. 4A is a schematic cross-sectional view of the hidden vehicle door handle mounted to the panel according to an embodiment of the present disclosure.

FIG. 4B is a schematic cross-sectional view of the hidden vehicle door handle mounted to the panel according to a further embodiment of the present disclosure.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a tolerance adjuster for easily and reliably mounting a hidden vehicle door handle to an interior sheet metal inside a vehicle door such that the hidden vehicle door handle is flush with an exterior sheet metal.

According to an aspect of the present disclosure, the present disclosure provides a tolerance adjuster, including a housing, a fastener and a centering structure. The housing is a vertically through cylindrical body and includes an inlet and an outlet that are opposite to each other, and the housing defines a channel. The fastener is arranged partially in the channel. The centering structure is cooperatively connected to the fastener and the housing such that the fastener is movable axially back and forth in the channel and the fastener is kept substantially on a central axis of the housing.

According to an aspect of the present disclosure, the centering structure includes a first engagement portion, a second engagement portion and a plurality of ribs. The first engagement portion is configured to be removably engaged with the housing. The second engagement portion is configured to be engaged with the fastener. The plurality of ribs extend between the first engagement portion and the second engagement portion and are circumferentially spaced apart from each other.

According to an aspect of the present disclosure, the plurality of ribs spirally extend between the first engagement portion and the second engagement portion.

According to an aspect of the present disclosure, the plurality of ribs are elastic elements. The elastic elements are configured to be deformable such that the fastener is movable axially back and forth in the channel and the fastener is kept substantially on the central axis of the housing.

According to an aspect of the present disclosure, the plurality of ribs are disposed symmetrically in a circumferential direction.

According to an aspect of the present disclosure, the first engagement portion and the second engagement portion of the centering structure are disposed coaxially with the housing.

According to an aspect of the present disclosure, the size of the first engagement portion is no less than the size of the second engagement portion.

According to an aspect of the present disclosure, the fastener includes a head, a flange and a fastening portion. The head and the fastening portion are connected axially, and the flange is disposed at a meeting position between the head and the fastening portion and extends radially. The centering structure and the fastener are configured such that: the second engagement portion of the centering structure is engaged with the head of the fastener to prevent the head from moving radially relative to the second engagement portion. The centering structure and the fastener are also configured such that: the elastic element of the centering structure is compressed such that the second engagement portion of the centering structure abuts against the flange of the fastener to prevent the fastener from being disengaged axially from the housing.

According to an aspect of the present disclosure, the head of the fastener is cylindrical, and the second engagement portion of the centering structure is an annular cylinder. The second engagement portion covers a part of the head to prevent the second engagement portion from being disengaged from the head.

According to an aspect of the present disclosure, the first engagement portion of the centering structure is mounted at the inlet of the housing. The head and the flange of the fastener are arranged inside the housing, and the fastening portion of the fastener extends to the outside of the housing from the outlet of the housing.

According to an aspect of the present disclosure, the tolerance adjuster further includes a support member mounted at the outlet of the housing and configured to support the fastener.

According to an aspect of the present disclosure, the support member includes an opening aligned with the outlet of the housing. Inner diameters of the opening and the outlet are greater than an outer diameter of the fastening portion of the fastener such that the fastener is movable radially. The flange of the fastener is arranged on the support member. The fastening portion of the fastener extends to the outside of the housing from the opening.

According to an aspect of the present disclosure, the tolerance adjuster is configured such that: an exterior wall of the housing is mounted to a base of a hidden vehicle door handle at a predetermined axial position thereof. The fastener is fastened to a vehicle interior panel such that the hidden vehicle door handle is mounted to the vehicle interior panel.

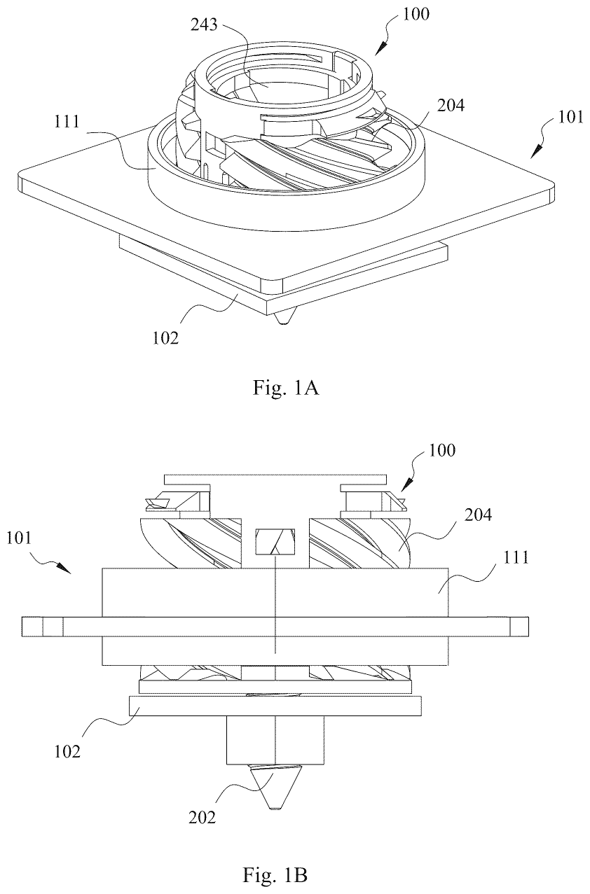

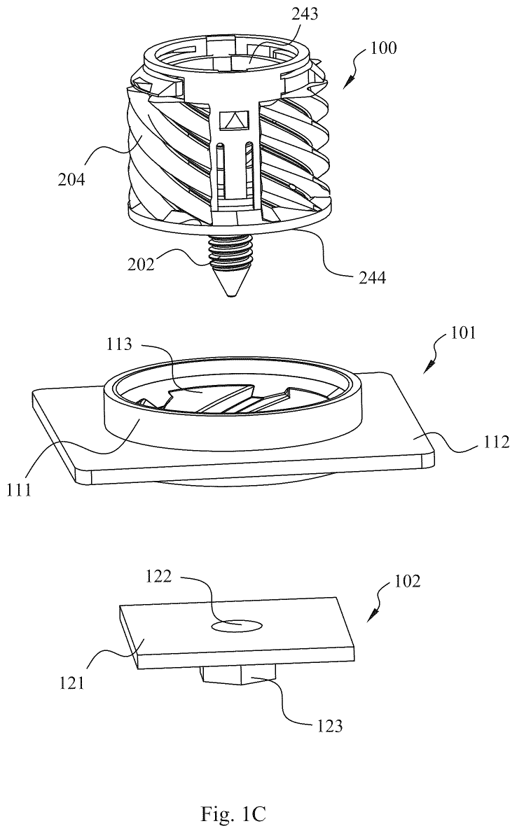

FIG. 1A is a structural schematic diagram of a tolerance adjuster used to mount a hidden vehicle door handle of a vehicle to a panel of the vehicle according to the present disclosure, to illustrate a positional relationship and a cooperative relationship between the tolerance adjuster and the hidden vehicle door handle and panel of the vehicle. FIG. 1B is a front view of FIG. 1A, and FIG. 1C is an exploded view of FIG. 1A.

As shown in FIGS. 1A-1C, a base 101 of the hidden vehicle door handle of the vehicle is mounted to a panel 102 of the vehicle by means of a tolerance adjuster 100. In an embodiment, the panel 102 is an interior sheet metal of the vehicle. The figures illustrate a part of the base 101 of the hidden vehicle door handle of the vehicle and a part of the interior sheet metal 102 of the vehicle.

The tolerance adjuster 100 includes a housing 204 and a fastener 202. The base 101 of the hidden vehicle door handle of the vehicle includes a main body plate 112, and the main body plate 112 is provided with a flange 111 and an opening 113 penetrating through the flange. The flange 111 extends upward from the main body plate 112 in a circumferential direction of the opening 113. The flange 111 is annular. The opening 113 runs through the flange 111. In an embodiment, the base 101 is integrally formed. In other embodiments, the base 101 includes other suitable structures.

The tolerance adjuster 100 is mounted in the base 101 of the hidden vehicle door handle of the vehicle via the housing 204. In an embodiment, the outside of the housing 204 of the tolerance adjuster 100 is provided with external threads, and the insides of the opening 113 and the flange 111 of the base 101 of the hidden vehicle door handle are provided with internal threads that match the external threads of the housing 204. With the above-mentioned external threads and internal threads, the tolerance adjuster 100 may be screwed into the base 101 of the hidden vehicle door handle.

The housing 204 of the tolerance adjuster 100 is a vertically through cylindrical body and includes an inlet 243 and an outlet 244 that are opposite to each other. The fastener 202 extends out of the housing 204 from the outlet 244. The panel 102 includes a main body plate 121, and the main body plate 121 is provided with a flange 123 and an opening 122 penetrating through the flange. The flange 123 extends downward from the main body plate 121 in a circumferential direction of the opening 122. The flange 123 is annular. The opening 122 runs through the flange 123. In an embodiment, the panel 102 is integrally formed.

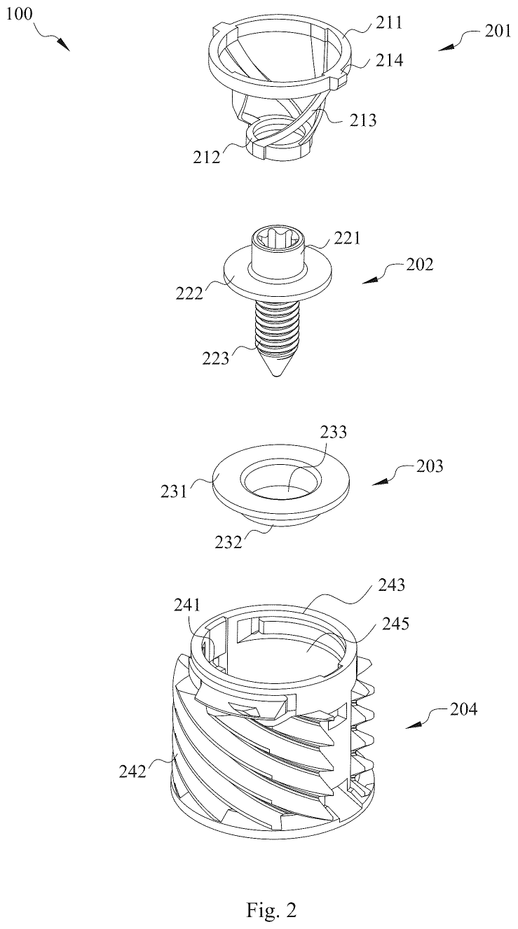

The fastener 202 extending out of the housing 204 is configured to fasten into the panel 102. In an embodiment, the fastener 202 is a screw having external threads. The insides of the opening 122 and the flange 123 of the panel 102 are provided with internal threads that match the external threads of the fastener 202. With the external threads and the internal threads, the fastener 202 of the tolerance adjuster 100 may be screwed into the panel 102. In an embodiment, a tool (not shown) passes through the inlet 243 of the housing 204 to be engaged with a head 221 of the fastener 202 (see FIG. 2). When the fastener 202 is aligned or approximately aligned with the opening 122 of the panel 102, the tool is rotated to fasten the fastener 202 of the tolerance adjuster 100 into the opening 122 of the panel 102. When a bottom surface of the housing 204 of the tolerance adjuster 100 is in contact with a top surface of the main body plate 121 of the panel 102, the tolerance adjuster 100 is mounted in place on the panel 102.

The tolerance adjuster 100 is mounted via its housing 204 to the base 101 of the hidden vehicle door handle, and the tolerance adjuster 100 is mounted via its fastener 202 to the panel 102, such that the tolerance adjuster 100 can install the base 101 of the hidden vehicle door handle to the panel 102. Since the tolerance adjuster 100 may be mounted to the main body plate 112 of the base 101 of the hidden vehicle door handle at a predetermined position (e.g., a predetermined longitudinal position) of its housing 204, and the tolerance adjuster 100 is engaged with the top surface of the main body plate 121 of the panel 102 via the bottom surface of its housing 204, the distance between the main body plate 112 of the base 101 of the hidden vehicle door handle and the main body plate 121 of the panel 102 can be adjusted correspondingly by adjusting the predetermined position, thereby adjusting the distance between the hidden vehicle door handle and the panel 102 (e.g., the interior sheet metal of the vehicle). The hidden vehicle door handle typically needs to be aligned with an exterior sheet metal of the vehicle to ensure the vehicle's aesthetic appeal. Thus, the hidden vehicle door handle can be easily aligned with the exterior sheet metal of the vehicle by appropriately adjusting the distance between the hidden vehicle door handle (e.g., its base) and the interior sheet metal (e.g., the panel 102) of the vehicle.

According to the present disclosure, the tolerance adjuster 100 further includes a centering structure 201 (see FIG. 2) such that the fastener 202 of the tolerance adjuster 100 is movable axially back and forth in the housing 204 and the fastener 202 is kept substantially on a central axis of the housing 204. According to the present disclosure, the expression of “substantially” is added in consideration of the fact that it may be difficult in practice to achieve a completely error-free location on the central axis. The expression of “substantially on the central axis” actually means “on the central axis”. According to the present disclosure, the tolerance adjuster 100 enables easy installation of the hidden vehicle door handle, as described in detail below.

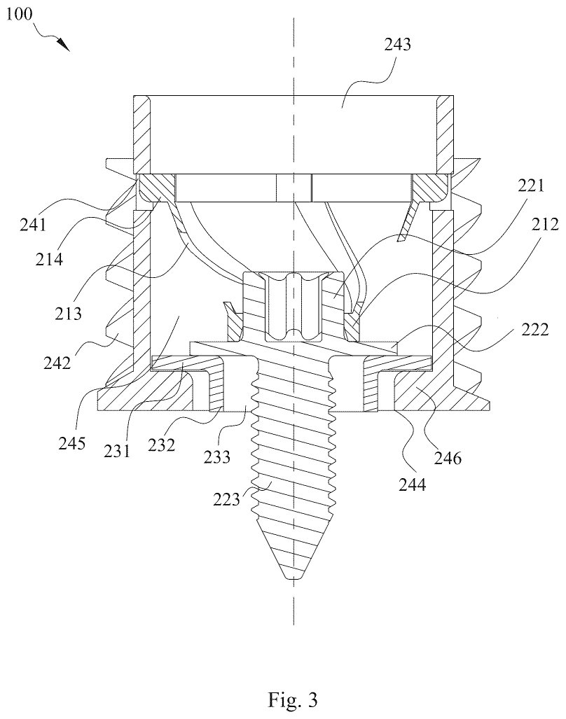

FIG. 2 is an exploded view of the tolerance adjuster 100, and FIG. 3 is a cross-sectional view of the tolerance adjuster 100 in an assembled state, to illustrate various components of the tolerance adjuster 100, and positional relationships and cooperative relationships between these components.

As shown in FIGS. 2 and 3, the tolerance adjuster 100 includes a centering structure 201, a fastener 202, a support member 203 and a housing 204. The housing 204 is a vertically through cylindrical body and includes an inlet 243 and an outlet 244 that are opposite to each other. A channel 245 is formed in the housing 204. The fastener 202 is arranged partially in the channel 245 of the housing 204. The centering structure 201 is configured to be cooperatively connected to the fastener 202 and the housing 204 such that the fastener 202 is movable axially back and forth in the channel 245 of the housing 204 and the fastener 202 is kept substantially on the central axis of the housing 204.

The centering structure 201 includes a first engagement portion 211, a second engagement portion 212 and a plurality of ribs 213. The plurality of ribs 213 extend between the first engagement portion 211 and the second engagement portion 212 and are circumferentially spaced apart from each other. More specifically, the plurality of ribs 213 spirally extend between the first engagement portion 211 and the second engagement portion 212. The plurality of ribs 213 are elastic elements configured to be deformable such that the fastener 202 is movable axially back and forth in the channel 245 and the fastener 202 is kept substantially on the central axis of the housing 204. The plurality of ribs 213 are disposed symmetrically in a circumferential direction.

The first engagement portion 211 of the centering structure 201 is configured to be removably engaged with the housing 204. The first engagement portion 211 is mounted at the inlet 243 of the housing 204. The first engagement portion 211 includes a protrusion 214. The housing 204 is provided with an opening 241. The opening 241 is adjacent to the inlet 243 of the housing 204. The protrusion 214 of the first engagement portion 211 of the centering structure 201 is configured to be removably snapped into the opening 241 of the housing 204, such that the first engagement portion 211 of the centering structure 201 is removably engaged with the housing 204. FIG. 2 illustrates two protrusions 214 and two openings 241. In other embodiments, the first engagement portion 211 includes other suitable numbers of protrusions 214, and the housing 204 includes other suitable numbers of openings 241. The first engagement portion 211 includes other suitable structures to be removably engaged with the housing 204.

The second engagement portion 212 of the centering structure 201 is configured to be engaged with the fastener 202. The fastener 202 includes a head 221, a flange 222 and a fastening portion 223. The head 221 and the fastening portion 223 are connected axially, and the flange 222 is disposed at a meeting position between the head 221 and the fastening portion 223 and extends radially. The second engagement portion 212 of the centering structure 201 is engaged with the head 221 of the fastener 202 to prevent the head 221 from moving radially relative to the second engagement portion 212. When the fastener 202 is mounted into the tolerance adjuster 100, as shown in FIG. 3, the head 221 and the flange 222 of the fastener 202 are arranged inside the housing 204. The fastening portion 223 of the fastener 202 extends to the outside of the housing 204 from the outlet 244 for fastening into the panel 102 (see FIGS. 1A-1C).

The support member 203 is mounted at the outlet 244 of the housing 204. The support member 203 is configured to support the fastener 202. The support member 203 includes a main body portion 231 and a flange 232 extending axially from the main body portion 231. The main body portion 231 is annular. The main body portion 231 and the flange 232 form a through opening 233. A flange 246 is also provided at the bottom of the housing 204, and the flange 246 extends radially toward the center of the housing 204 to form an opening, i.e., the outlet 244 of the housing 204. The main body portion 231 of the support member 203 is configured to be arranged on the flange 246 of the housing 204, and the flange 232 of the support member 203 is inserted into the opening (i.e., the outlet 244) defined by the flange 246 of the housing 204. In an embodiment, an outer diameter of the main body portion 231 of the support member 203 is approximately the same as an inner diameter of the housing 204 to prevent the support member 203 from moving radially in the housing 204. In an embodiment, an outer diameter of the flange 232 of the support member 203 is approximately the same as an inner diameter of the outlet 244 of the housing 204 to prevent the support member 203 from moving radially in the housing 204. The opening 233 of the support member 203 is aligned with the outlet 244 of the housing 204, and the opening 233 is substantially disposed at a central axis of the outlet 244.

The flange 222 of the fastener 202 is arranged on the support member 203, and the fastening portion 223 of the fastener 202 extends to the outside of the housing 204 from the opening 233 of the support member 203. An inner diameter of the opening 233 of the support member 203 is greater than an outer diameter of the fastening portion 223 of the fastener 202, and an outer diameter of the flange 222 of the fastener 202 is less than an inner diameter of the housing 204 such that the fastener 202 is movable radially in the housing 204.

As shown in FIG. 3, in the assembled state, the protrusion 214 of the first engagement portion 211 of the centering structure 201 is snapped into the opening 241 of the housing 204. The plurality of ribs 213 of the centering structure 201 are configured to be compressed such that the second engagement portion 212 of the centering structure 201 abuts against the flange 222 of the fastener 202 to prevent the fastener 202 from being disengaged axially from the housing 204. The second engagement portion 212 of the centering structure 201 is engaged with the head 221 of the fastener 202 such that the second engagement portion 212 of the centering structure 201 will not be disengaged from the head 221 of the fastener 202 when the fastener 202 moves radially in the housing 204, thereby eliminating the need to reinstall the centering structure 201. The head 221 of the fastener 202 is cylindrical, the second engagement portion 212 of the centering structure 201 is an annular cylinder, and the second engagement portion 212 covers a part of the head 221 to prevent the second engagement portion 212 from being disengaged from the head 221.

The first engagement portion 211 and the second engagement portion 212 of the centering structure 201 are disposed coaxially with the housing 204. The size of the first engagement portion 211 is no less than the size of the second engagement portion 212. In an embodiment, the first engagement portion 211 and the second engagement portion 212 are concentric rings. In a natural state (i.e., when no external force is applied), the second engagement portion 212 is engaged with the fastener 202 such that the fastener 202 is kept substantially on the central axis of the housing 204. The fastener 202 is movable radially and axially in the housing 204 when the fastener 202 is subjected to an external force.

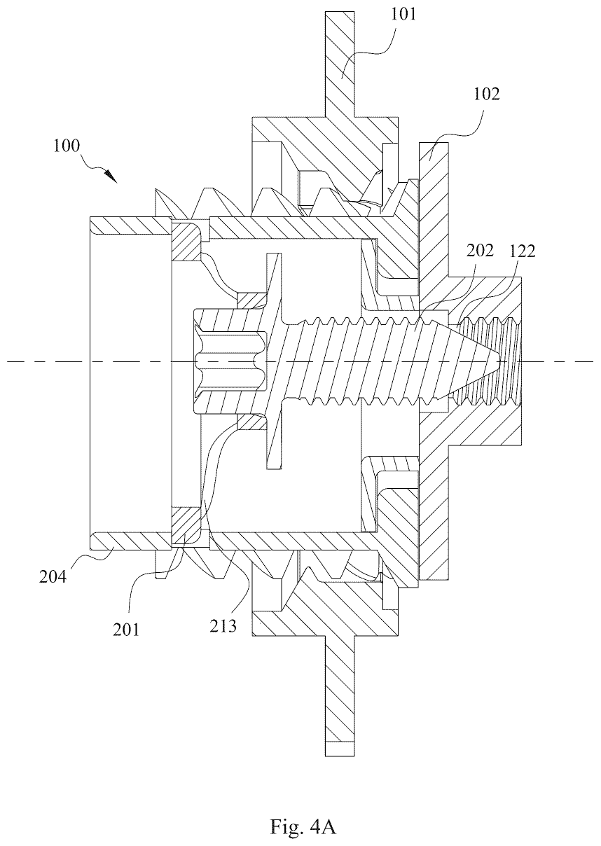

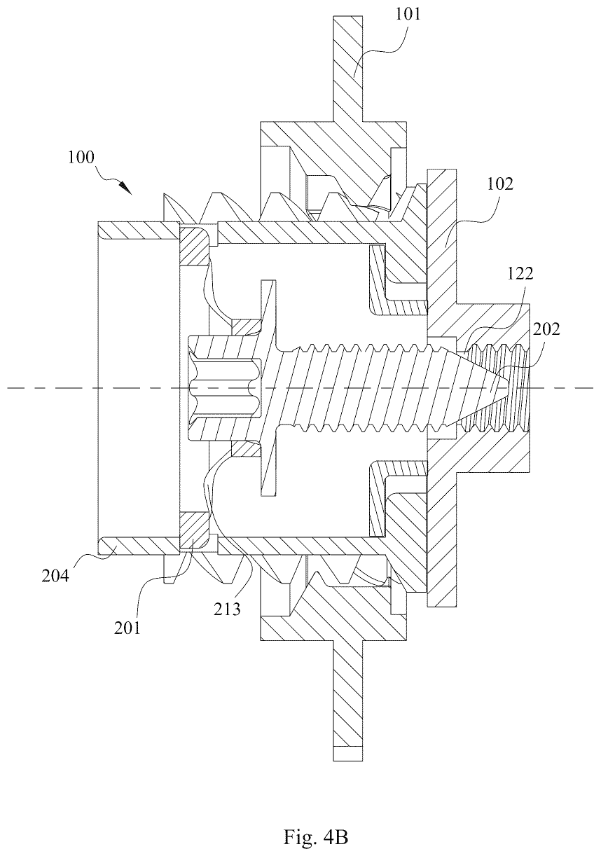

FIG. 4A is a schematic cross-sectional view of the hidden vehicle door handle mounted to the panel 102 according to an embodiment of the present disclosure, and FIG. 4B is a schematic cross-sectional view of the hidden vehicle door handle mounted to the panel 102 according to a further embodiment of the present disclosure. An exterior wall of the housing 204 of the tolerance adjuster 100 is mounted to the base 101 of the hidden vehicle door handle at a predetermined axial position thereof. The fastener 202 of the tolerance adjuster 100 is fastened into a vehicle interior panel such that the hidden vehicle door handle is mounted to the panel 102 of the vehicle.

As shown in FIGS. 4A-4B, the panel 102 (e.g., the interior sheet metal of the vehicle door) is vertically fixed to the vehicle, the tolerance adjuster 100 is mounted to the base 101 of the hidden vehicle door handle (oriented vertically), and the hidden vehicle door handle is arranged at a predetermined position to be aligned with the exterior sheet metal of the vehicle. The centering structure 201 substantially retains the fastener 202 on the central axis of the housing 204, such that the fastener 202 of the tolerance adjuster 100 can be easily inserted into the opening 122 of the panel 102 when the tolerance adjuster 100 is not aligned with the opening 122 of the panel 102, thereby fastening the fastener 202 into the panel 102. The centering structure 201 can reduce the offset between the tolerance adjuster 100 and the panel 102, making it easy to mount the tolerance adjuster 100 to the panel 102.

The centering structure 201 is configured such that the fastener 202 of the tolerance adjuster 100 is movable axially back and forth in the housing 204. During installation, the fastener 202 of the tolerance adjuster 100 is pressed substantially into the housing 204 such that the bottom surface of the housing 204 of the tolerance adjuster 100 abuts against the surface of the panel 102, which in turn aligns the hidden vehicle door handle on the tolerance adjuster 100, for example, with the exterior sheet metal of the vehicle. At this time, the installation of the hidden vehicle door handle is completed by fastening the tolerance adjuster 100 into the panel 102. Therefore, according to the present disclosure, the hidden vehicle door handle can be mounted to the panel 102 after being aligned with the exterior sheet metal of the vehicle, such that the hidden vehicle door handle can be mounted easily and reliably.

When the tolerance adjuster 100 is slightly not aligned with the panel 102, for example, when a tip of the fastener 202 of the tolerance adjuster 100 is aligned with an edge of the opening 122 of the panel 102, the plurality of ribs 213 of the centering structure 201 may press the fastener 202 into the opening 122 of the panel 102. That is, the fastener 202 is displaced axially, at which time the fastener 202 of the tolerance adjuster 100 may be fastened into the opening 122 of the panel 102 by using a tool.

As shown in FIG. 4A, in the process of fastening the fastener 202, the fastener 202 is moved radially (i.e., radially offset with respect to the central axis of the housing 204) in the housing 204 to be aligned with the opening 122 of the panel 102, thereby fastening the fastener 202 into the opening 122 of the panel 102. The second engagement portion 212 of the centering structure 201 is still engaged with (not disengaged from) the head 221 of the fastener 202 after the fastener 202 is moved radially, such that it is unnecessary to reassemble the centering structure 201.

FIG. 4B illustrates a partially installed state, in which the fastener 202 is fastened into the opening 122 of the panel 102 when the tolerance adjuster 100 is aligned with the panel 102, for example, when the fastener 202 of the tolerance adjuster 100 is disposed substantially at a central axis of the panel 102.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A tolerance adjuster, comprising:
a housing being a through cylindrical body and comprising an inlet and an outlet that are opposite to each other, and the housing forming a channel;
a fastener arranged partially in the channel; and
a centering structure cooperatively connected to the fastener and the housing such that the fastener is movable axially back and forth in the channel and the fastener is kept substantially on a central axis of the housing.

2. The tolerance adjuster according to claim 1, wherein the centering structure comprises:
a first engagement portion configured to be removably engaged with the housing;
a second engagement portion configured to be engaged with the fastener; and
a plurality of ribs extending between the first engagement portion and the second engagement portion and being spaced apart from each other in a circumferential direction.

3. The tolerance adjuster according to claim 2, wherein the plurality of ribs spirally extend between the first engagement portion and the second engagement portion.

4. The tolerance adjuster according to claim 2, wherein the plurality of ribs are elastic elements configured to be deformable such that the fastener is movable axially back and forth in the channel and the fastener is kept substantially on the central axis of the housing.

5. The tolerance adjuster according to claim 2, wherein the plurality of ribs are disposed symmetrically in the circumferential direction.

6. The tolerance adjuster according to claim 2, wherein
the first engagement portion and the second engagement portion of the centering structure are disposed coaxially with the housing.

7. The tolerance adjuster according to claim 6, wherein the size of the first engagement portion is no less than the size of the second engagement portion.

8. The tolerance adjuster according to claim 4, wherein
the fastener comprises a head, a flange and a fastening portion, the head and the fastening portion are connected axially, and the flange is disposed at a meeting position between the head and the fastening portion and extends in a radial direction,
wherein the centering structure and the fastener are configured such that
the second engagement portion of the centering structure is engaged with the head of the fastener to prevent the head from moving relative to the second engagement portion in the radial direction; and
the elastic element of the centering structure is compressed such that the second engagement portion of the centering structure abuts against the flange of the fastener to prevent the fastener from being axially disengaged from the housing.

9. The tolerance adjuster according to claim 8, wherein the head of the fastener is cylindrical, the second engagement portion of the centering structure is an annular cylinder, and the second engagement portion covers a part of the head to prevent the second engagement portion from being disengaged from the head.

10. The tolerance adjuster according to claim 8, wherein
the first engagement portion of the centering structure is mounted at the inlet; and
the head and the flange of the fastener are arranged inside the housing, and the fastening portion of the fastener extends to the outside of the housing from the outlet.

11. The tolerance adjuster according to claim 10, wherein the tolerance adjuster further comprises:
a support member mounted at the outlet of the housing and configured to support the fastener.

12. The tolerance adjuster according to claim 11, wherein
the support member comprises an opening aligned to the outlet, and inner diameters of the opening and the outlet are greater than an outer diameter of the fastening portion of the fastener such that the fastener can move in the radial direction; and
the flange of the fastener is arranged on the support member, and the fastening portion of the fastener extends to the outside of the housing from the opening.

13. The tolerance adjuster according to claim 1, wherein the tolerance adjuster is configured such that
an exterior wall of the housing is mounted to a base of a hidden vehicle door handle at a predetermined axial position thereof; and
the fastener is fastened to a vehicle interior panel such that the hidden vehicle door handle is mounted to the vehicle interior panel.
